(19) United States
(12) Patent Application Publication
(10) Pub. No.: US 2026/0011990 A1
(43) Pub. Date: Jan. 8, 2026

(54) MULTI-STAGE LOCKING TIE FOR PROTECTIVE SLEEVE APPLICATIONS

(71) Applicant: Panduit Corp., Tinley Park, IL (US)

(72) Inventor: Michael P. Hajduch, Munster, IN (US)

(73) Assignee: Panduit Corp., Tinley Park, IL (US)

(21) Appl. No.: 18/970,306

(22) Filed: Dec. 5, 2024

Related U.S. Application Data
(60) Provisional application No. 63/668,554, filed on Jul. 8, 2024.

(51) Int. Cl. H02G 3/06; F16L 9/22; H02G 3/04; H02G 9/02

(52) U.S. Cl. CPC H02G 3/06; F16L 9/22; H02G 3/0481; H02G 9/02

(57) ABSTRACT

A multi-stage locking tie system for assisting in clamping together protective half sleeves that are mated together over an elongated object to protect the elongated object from environmental conditions. In operation, the multi-stage locking tie is configured to engage into at least two distinct locking stages to enable faster and more secure assembly of the protective sleeves.

### CROSS-REFERENCE TO RELATED APPLICATION(S)

This application claims benefit to U.S. Provisional Patent Application No. 63/668,554, filed Jul. 8, 2024, the entirety of which is hereby incorporated by reference herein.

### FIELD OF TECHNOLOGY

This disclosure relates to a multi-stage locking tie system for use in assembling protective sleeves used in, for example, subsea offshore subsea applications.

### BACKGROUND

Offshore energy production has been around for decades and until recently was typically directed to oil and gas production. However, more recently renewable energy sources are becoming more common and offshore installations are becoming popular in areas where available land may be too expensive or not available. Regardless of the type of offshore installation, power and/or data transmission are necessary which then require cables for the transmission of the power and/or data.

The cables used for offshore installations need to be protected from abrasion, sharp objects, kinks, and other impediments that can be found in the harsh subsea environment. One type of abrasion protection includes split tubular polyurethane half sleeves that are held together with banding members. This style of protective sleeve has proven to be effective at protecting the cables, but it is difficult and time consuming to install. The two known factors associated with laying subsea cables are suitable weather conditions and the extremely high cost of the ship/crew to lay the cables. While the weather conditions are favorable, installation assembly crews must lay the cables along with the cable protection systems quickly to control costs before unfavorable weather conditions set in to delay the installation. The cable laying speed is normally dictated by the time to install the protective sleeves and banding.

### SUMMARY

According to an embodiment, a multi-stage locking tie is disclosed. The multi-stage locking tie including a band, a locking pin positioned at a first end of the band, the locking pin including a first groove and a second groove, and a locking receptacle positioned at a second end of the band, the locking receptacle including a locking cavity configured to hold the locking pin.

According to an embodiment, a protective sleeve system is disclosed. The protective sleeve system including a top half sleeve including a top channel, a bottom half sleeve including a bottom channel and configured to mate with the top half sleeve, wherein when the top half sleeve and the bottom half sleeve are mated the top channel and the bottom channel are combined to form a tie channel, and a multi-stage locking tie configured to be installed within the tie channel. The multi-stage locking tie including a band, a locking pin positioned at a first end of the band, the locking pin including a first groove and a second groove, and a locking receptacle positioned at a second end of the band, the locking receptacle including a locking cavity configured to hold the locking pin.

To provide a more efficient cable protection system, a multi-stage locking tie system that dramatically increases the speed of installing protective sleeves is disclosed.

### BRIEF DESCRIPTION OF THE DRAWINGS

FIG. 1 is a perspective view of a multi-stage locking tie system used to assemble protective sleeves, according to an embodiment.

FIG. 2 is a magnified perspective view showing a portion of the multi-stage locking tie system in various stages of installation onto the protective sleeves illustrated in FIG. 1, according to an embodiment.

FIG. 3 is a side view of the multi-stage locking tie system being installed onto the protective sleeves using an installation device, according to an exemplary embodiment.

FIG. 4 is a magnified side view of the multi-stage locking tie system being installed onto the protective sleeves using the installation device illustrated in FIG. 3, according to an exemplary embodiment.

FIG. 5A is a perspective view of the multi-stage locking tie, according to an exemplary embodiment.

FIG. 5B is a side view of a locking pin included in the multi-stage locking tie illustrated in FIG. 5A, according to an exemplary embodiment.

FIG. 6A is a perspective view of the multi-stage locking tie in a first locking stage, according to an exemplary embodiment.

FIG. 6B is a cross-sectional view of the locking pin and a locking receptacle included in the multi-stage locking tie illustrated in FIG. 6A, according to an exemplary embodiment.

FIG. 7A is a perspective view of the multi-stage locking tie in a second locking stage, according to an exemplary embodiment.

FIG. 7B is a cross-sectional view of the locking pin and a locking receptacle included in the multi-stage locking tie illustrated in FIG. 7A, according to an exemplary embodiment.

### DETAILED DESCRIPTION

This disclosure describes embodiments of a multi-stage locking tie configured to be wrapped around a multi-part protective sleeve system (e.g., two half sleeves) and locked to secure the protective sleeves together. In operation, the multi-stage locking tie is configured to engage into at least two distinct locking stages to enable faster and more secure assembly of the protective sleeve system, as will be described in more detail below.

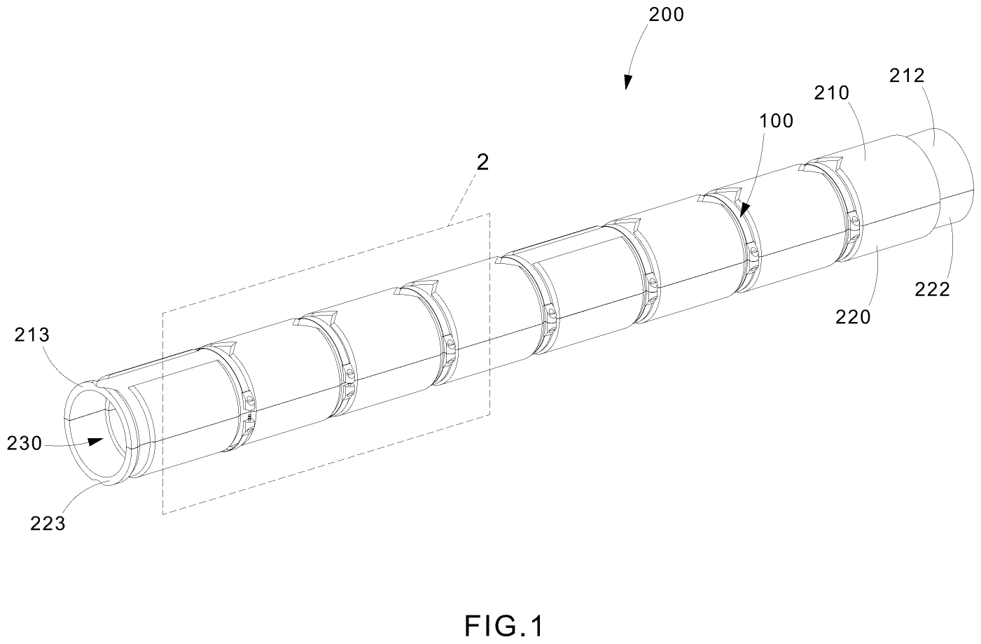

FIG. 1 shows a perspective view of a protective sleeve system 200 including a top half sleeve 210 and a bottom half sleeve 220. The protective sleeve system 200 is shown to use multi-stage locking ties 100 to secure the top half sleeve 210 and the bottom half sleeve 220 together in a mated configuration, as shown in FIG. 1. The top half sleeve 210 includes a male end 212 and a female end 213. The bottom half sleeve 220 includes a male end 222 and a female end 223. When the top half sleeve 210 and the bottom half sleeve 220 are mated together, they form a channel 230 for housing, for example, a cable.

To provide additional mating strength for keeping the top half sleeve 210 and the bottom half sleeve 220 mated together, the multi-stage locking ties 100 are used to hold the top half sleeve 210 and the bottom half sleeve 220 together. The multi-stage locking ties 100 are installed into channels 211, 221 formed on the top half sleeve 210 and the bottom half sleeve 220.

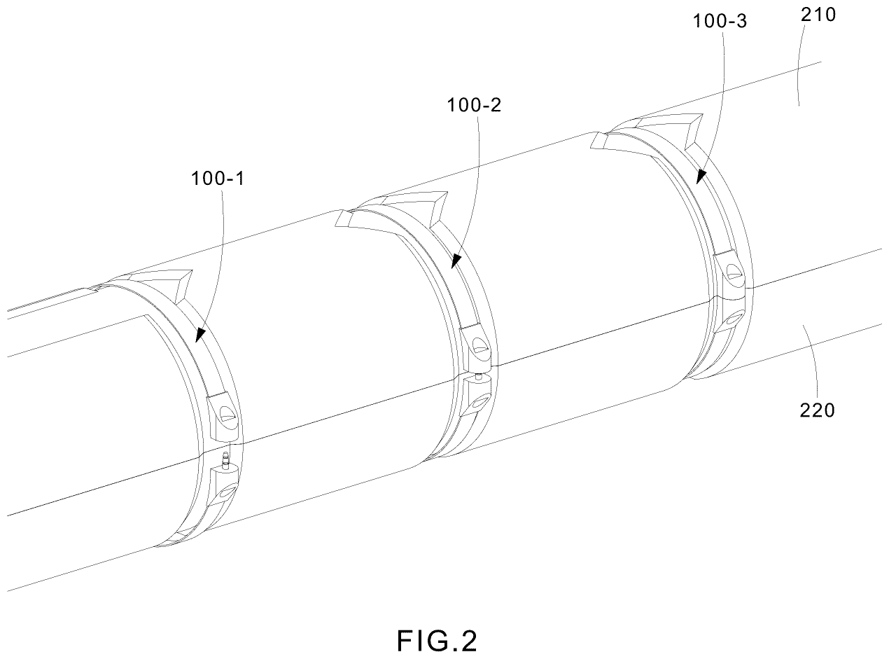

FIG. 2 shows a perspective view of a portion of the protective sleeve system 200 illustrated in FIG. 1. The portion of the protective sleeve system 200 shown in FIG. 2 is provided to illustrate the multi-stage locking ties 100 in different stages of locking. For example, the multi-stage locking tie 100-1 is shown in an open stage where there is no locking engagement, the multi-stage locking tie 100-2 is shown in a first locking stage, and the multi-stage locking tie 100-3 is shown in a second locking stage. Further description of the different locking stages, and the process for configuring the multi-stage locking tie 100 into the different locking stages, will be provided below.

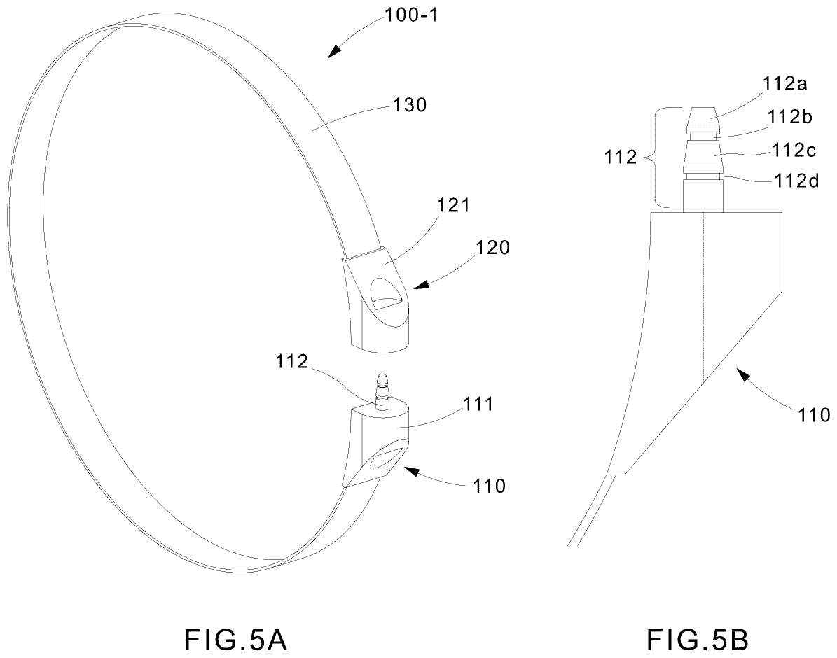

FIG. 5A shows a perspective view of the multi-stage locking tie 100 in the open stage. The multi-stage locking tie 100 includes a locking end 110, a locking receptacle 120, and a tie band 130, where the locking pin 112 and the locking receptacle 120 are positioned at opposite ends of the tie band 130. The locking end 110 includes a body 111 and a locking pin 112. The locking receptacle 120 includes a body 121, where the body 121 includes an inner chamber 122 that works as a locking cavity for receiving the locking pin 112. The multi-stage locking tie 100 may be made from a non-corrosive metal such as, for example, titanium, stainless steel, or other non-corrosive metal.

A length of the multi-stage locking tie 100 may be a predetermined length to clamp around protective sleeves of a known circumference being used for specific applications protecting cables having a known circumference size. Manufacturing the multi-stage locking tie 100 in the predetermined lengths is advantageous as there will be no need for extra length that would need to be cut off after installation around the protective sleeve system 200, thus saving yet another potential installation step and reducing waste in the form of scrap pieces that would otherwise be cut off. Composing the multi-stage locking tie 100 in the predetermined lengths is also advantageous for providing a consistent amount of tension force along a length of the protective sleeve system 200 being installed.

As shown in the magnified view of the locking pin 112 shown in FIG. 5B, the locking pin 112 includes a first-stage engagement member 112a and a first-stage locking groove 112b positioned under the first-stage engagement member 112a. Then under the first-stage locking groove 112b, the locking pin 112 further includes a second-stage engagement member 112c and a second-stage locking groove 112d. Both the first-stage engagement member 112a and the second-stage engagement member 112c have a conical shape with a base and angled walls. A circumference of the base of the second-stage engagement member 112c is larger than a circumference of the base of the first-stage engagement member 112a.

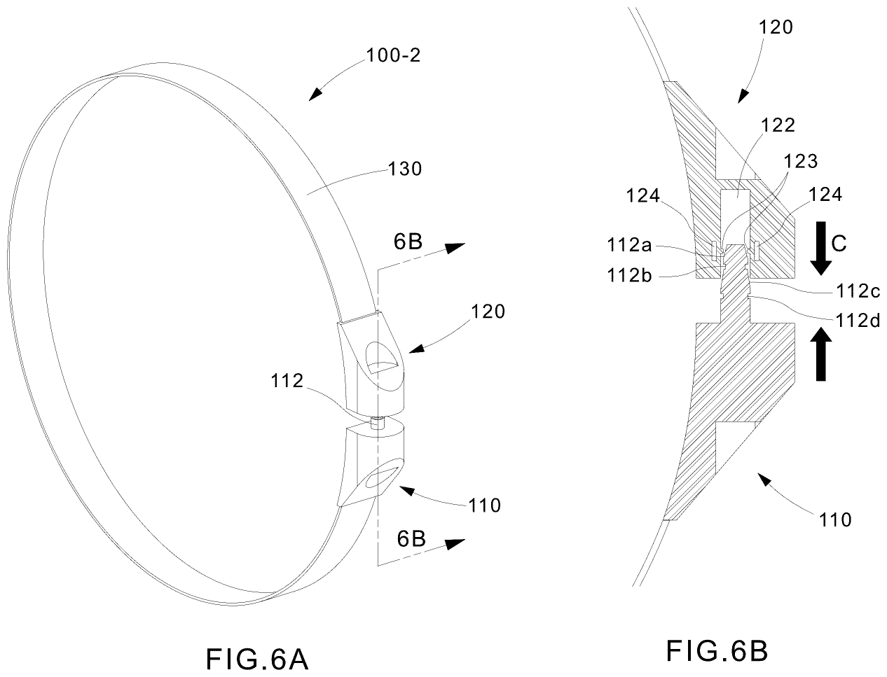

The locking receptacle 120 includes a body 121, where the body 121 includes an opening to an inner chamber 122 for receiving the locking pin 112. FIG. 6A shows a perspective view of the multi-stage locking tie 100 in the first locking stage. FIG. 6B shows a cross-sectional view of the multi-stage locking tie 100 in the first locking stage, where the first stage engagement member 112a has pushed past a locking ridge 123 inside the inner chamber 122, to where the locking ridge 123 sits within the first-stage locking groove 112b. This first locking stage is achieved by inserting the locking pin 112 into the inner chamber 122 of the locking receptacle 120 and compressing them together along the compression direction C until the locking ridge 123 reaches into at least the first-stage locking groove 112b. The locking receptacle 120 may further include a space 124 behind the locking ridge 123 for enabling the locking ridge 123 to flex, at least in part, into the space 124 when the first-stage engagement member 112a moves past the locking ridge 123.

When the locking pin 112 is inserted into the inner chamber 122 of the locking receptacle 120 to engage the first locking stage, the compression force for pushing the first-stage engagement member 112a past the locking ridge 123 may be achieved using the manual work of an installer without the need for a separate tool. This provides a quick and efficient first stage installation step. According to some embodiments, the locking pin 112 may be removed from the inner chamber 122 in the first locking stage using manual force as well.

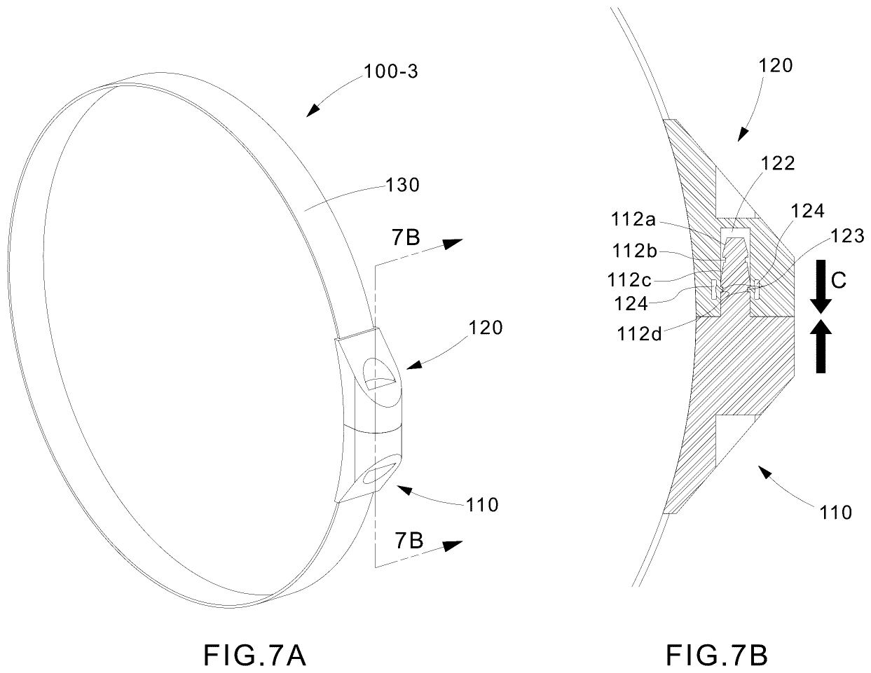

FIG. 7A shows a perspective view of the multi-stage locking tie 100 in the second locking stage. FIG. 7B shows a cross-sectional view of the multi-stage locking tie 100 in the second locking stage, where the second stage engagement member 112c has pushed past the locking ridge 123 inside the inner chamber 122, to where the locking ridge 123 sits within the second-stage locking groove 112d or beyond. This second locking stage is achieved by inserting the locking pin 112 into the inner chamber 122 of the locking receptacle 120 and compressing them together along the compression direction C until the locking ridge 123 reaches into at least the second-stage locking groove 112d. The locking receptacle 120 may further include the space 124 behind the locking ridge 123 for enabling the locking ridge 123 to flex, at least in part, into the space 124 when the second-stage engagement member 112c moves past the locking ridge 123.

When the locking pin 112 is inserted into the inner chamber 122 of the locking receptacle 120 to engage the second locking stage, the compression force for pushing the second-stage engagement member 112c past the locking ridge 123 may be achieved using the manual work of an installer, or with a separate tool to achieve greater compression force. This still provides a quick and efficient second stage installation step. According to some embodiments, the locking pin 112 may be removed from the inner chamber 122 in the second locking stage using a tool due to the stronger locking hold provided in the second locking stage when compared to the first locking stage. According to other alternative embodiments, the locking pin 112 may not be removable from the inner chamber 122 in the second locking stage without breaking the locking receptacle 120 or the locking end 110, and likely the tie band 130 will have to be cut to remove the multi-stage locking tie 100.

To protect a longer length of an elongated member (e.g., cable carrying conductor, fiber, pipes, or other member that needs to be protected from environmental conditions), multiple numbers of the protective sleeve system 200 may be attached together to provide continuous protection for the elongated member housed within the continuous channel 230 that is formed from the combination of the protective sleeve systems 200.

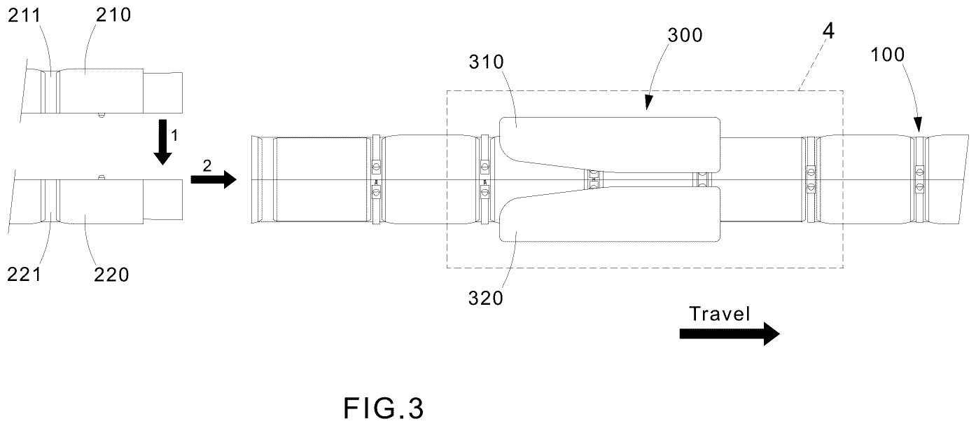

During an installation process, the top half sleeve 210 may be fitted onto the bottom half sleeve 220 to mate the two together, as shown in FIG. 3. An elongated member may be held within the channel 230 formed by the top half sleeve 210 and the bottom half sleeve 220 being mated together. After the top half sleeve 210 and the bottom half sleeve 220 are mated together, the male end 212 and the male end 222 form an attachment end that will fit into the channel 230 of a subsequent protective sleeve system 200 to continue forming a length of the protective sleeve system 200 to cover the elongated member housed within the channel 230, as also shown in FIG. 3.

FIG. 3 also shows an installation tool 300 that may be used during an installation process of the protective sleeve system 200, according to an exemplary embodiment. The installation tool 300 includes a top compression member 310 and a bottom compression member 320. The installation tool 300 includes a compression stage section where the top compression member 310 and the bottom compression member 320 both include a ramped section that includes an angled surface for compressing the protective sleeve system 200 that travels between the top compression member 310 and the bottom compression member 320 in the Travel direction shown in FIG. 3. The installation tool 300 also includes a locking stage section where the top compression member 310 and the bottom compression member 320 are substantially parallel to each other for maintaining the protective sleeve system 200 in a compressed state while the protective sleeve system 200 in traveling between the top compression member 310 and the bottom compression member 320.

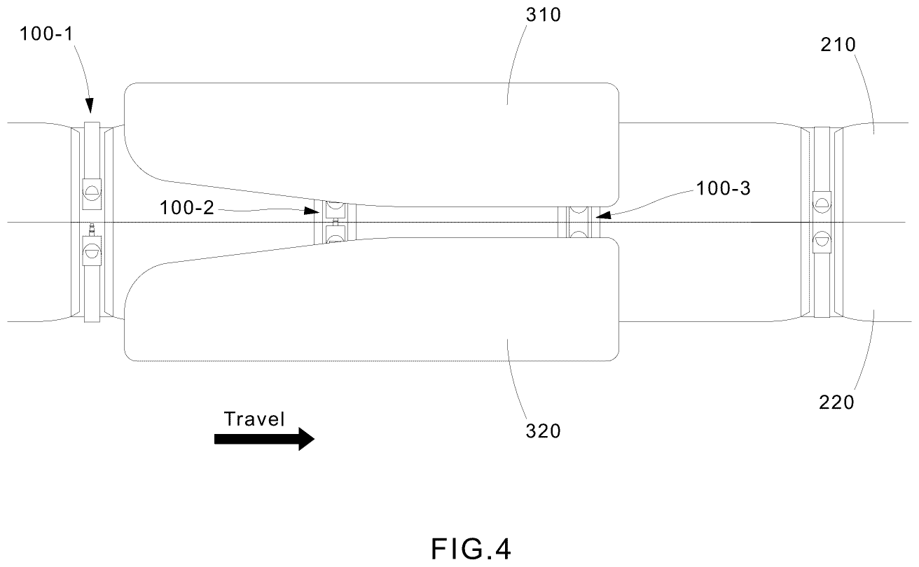

FIG. 4 shows a magnified view of the installation tool 300 being utilized to compress the multi-stage locking tie onto the protective sleeve system 200 during an installation process. In describing this exemplary installation process, the top half sleeve 210 and the bottom half sleeve 220 are first mated together. Then, multi-stage locking ties 100 may be installed into the channels 211, 221. As shown in FIG. 4, the multi-stage locking ties 100 may be compressed into the first locking stage prior to engaging the installation tool 300. According to alternative embodiments, the multi-stage locking ties 100-1 may be left in the open stage prior to engaging the installation tool 300. After mating the top half sleeve 210 and the bottom half sleeve 220 together and installing the multi-stage locking ties 100, the protective sleeve system 200 travel down on rollers or a conveyer belt system in the Travel direction towards the installation tool 300. These steps that are enacted prior to the protective sleeve system 200 engaging the installation tool 300 may be considered part of the preparation stage.

After traveling down in the Travel direction, the protective sleeve system 200 will engage with the installation tool 300 to enter into the compression stage. During this compression stage, the top compression member 310 and the bottom compression member 320 work to ensure the multi-stage locking ties 100-2 are maintained in the first locking stage or compressed into the first locking stage if they were not already in the first locking stage. For example, for those multi-stage locking ties 100-1 that are still in the open stage may be compressed into the first locking stage during this compression stage of the installation tool. The multi-stage locking ties 100-2 will continue to be compressed as the protective sleeve system 200 moves in the Travel direction due to the ramped shape of the top compression member 310 and the bottom compression member 320.

When the multi-stage locking ties 100-3 reach the locking stage of the installation tool 300, the compression force being exerted between the top compression member 310 and the bottom compression member 320 onto the multi-stage locking ties 100 will compress the multi-stage locking ties 100-3 into the second locking stage. So, the multi-stage locking ties 100-3 are configured to compress into the second locking stage while traveling in the locking stage of the installation tool 300. After leaving the locking stage of the installation tool 300, the multi-stage locking ties 100 will be fully compressed into the second locking stage to assist in maintaining the mating of the top half sleeve 210 and the bottom half sleeve 220 together. In this way, the installation tool 300 provides an automated solution for compressing the multi-stage locking ties 100.

The sections comprising the top compression member 310 and the bottom compression member 320 may be comprised of one or more rollers. According to some embodiments, the one or more rollers may further be covered by a conveyor belt.

Although this disclosure describes embodiments where the multi-stage locking tie 100 is configured to have up to two locking stages, according to other embodiments a multi-stage locking tie may have a single locking stage, or more than two locking stages to provide more precise locking options.

Furthermore, while the particular embodiments described herein have been shown and described, it will be obvious to those skilled in the art that changes and modifications may be made without departing from the teachings of the multi-stage locking tie described herein. The matter set forth in the foregoing description and accompanying drawings is offered by way of illustration only and not as limitation. The scope of the different embodiments described herein are intended to be defined in the following claims when viewed in their proper perspective.

What is claimed is:

1. A multi-stage locking tie comprising:
a band;
a locking pin positioned at a first end of the band, the locking pin including a first groove and a second groove; and
a locking receptacle positioned at a second end of the band, the locking receptacle including a locking cavity configured to hold the locking pin.

2. The multi-stage locking tie of claim 1, wherein a circumference of a base of the second groove is larger than a circumference of a base of the first groove.

3. The multi-stage locking tie of claim 1, the locking receptacle further including a locking ridge formed along a circumference of the locking cavity.

4. The multi-stage locking tie of claim 1, wherein the first groove is configured to provide a first locking stage.

5. The multi-stage locking tie of claim 1, wherein the second groove is configured to provide a second locking stage.

6. The multi-stage locking tie of claim 1, the locking pin further comprising a first-stage engagement member, the first-stage engagement member including angled walls and positioned above the first groove.

7. The multi-stage locking tie of claim 1, the locking pin further comprising a second-stage engagement member, the second-stage engagement member including angled walls and positioned above the second groove.

8. A protective sleeve system comprising:
a top half sleeve including a top channel;
a bottom half sleeve including a bottom channel and configured to mate with the top half sleeve, wherein when the top half sleeve and the bottom half sleeve are mated the top channel and the bottom channel are combined to form a tie channel; and
a multi-stage locking tie configured to be installed within the tie channel, the multi-stage locking tie comprising:
a band;
a locking pin positioned at a first end of the band, the locking pin including a first groove and a second groove; and
a locking receptacle positioned at a second end of the band, the locking receptacle including a locking cavity configured to hold the locking pin.

9. The protective sleeve system of claim 8, wherein a circumference of a base of the second groove is larger than a circumference of a base of the first groove.

10. The protective sleeve system of claim 8, the locking receptacle further including a locking ridge formed along a circumference of the locking cavity.

11. The protective sleeve system of claim 8, wherein the first groove is configured to provide a first locking stage.

12. The protective sleeve system of claim 8, wherein the second groove is configured to provide a second locking stage.

13. The protective sleeve system of claim 8, the locking pin further comprising a first-stage engagement member, the first-stage engagement member including angled walls and positioned above the first groove.

14. The protective sleeve system of claim 8, the locking pin further comprising a second-stage engagement member, the second-stage engagement member including angled walls and positioned above the second groove.

15. The protective sleeve system of claim 8, wherein the protective sleeve system is configured to move through an installation tool, the installation tool including a compression stage section and a locking stage section, wherein the locking pin is configured to be compressed up to at least the first groove prior to entering the compression stage section of the installation tool.

16. The protective sleeve system of claim 8, wherein the protective sleeve system is configured to move through an installation tool, the installation tool including a compression stage section and a locking stage section, wherein the locking pin is configured to compress into the locking cavity up to at least the first groove when the multi-stage locking tie is within the compression stage section of the installation tool.

17. The protective sleeve system of claim 8, wherein the protective sleeve system is configured to move through an installation tool, the installation tool including a compression stage section and a locking stage section, wherein the locking pin is configured to compress into the locking cavity up to at least the second groove when the multi-stage locking tie is within the locking stage section of the installation tool.
